(19) United States
(12) Patent Application Publication
(10) Pub. No.: US 2007/0051837 A1
(43) Pub. Date: Mar. 8, 2007

(54) Rock crusher having overload detection

(75) Inventor: Jon Juhlin, Pleasant Hill, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Johnson Crushers International

(21) Appl. No.: 11/220,632

(22) Filed: Sep. 6, 2005

(51) Int. Cl. B02C 25/00

(52) U.S. Cl. 241/37

(57) ABSTRACT

A rock crusher including a bowl and cone mounted to define a determined but fluctuating spacing in which rocks are received and crushed. A relief mechanism provides a resistive force and permits opening of the determined spacing when the crushing forces are sufficiently large to overcome that resistive force. A programmable proximity sensor detects the opening of the determined spacing and discriminately signals the occurrence of said opening. The programmable proximity sensor enables the setting of a specified opening beyond which a change in state occurs, both when the specified opening is exceeded and when said specified opening is reestablished.

### FIELD OF THE INVENTION

This invention relates to cone type rock crushers and more particularly to the detection of an undesired overload condition.

### BACKGROUND OF INVENTION

Rock crushing machines (rock crushers), as contemplated for this invention, are utilized to reduce large rocks as may be removed from a rock quarry to a desired size, e.g., for use as a road bed. Conveyors are used to convey large rocks (or other friable material) to the rock crusher. The rock crusher typically includes a conically shaped bowl which is part of an upper rock crusher assembly. The bowl overlies a conically shaped crushing head (cone) supported by a primary crusher support. The cone both oscillates and rotates relative to the crusher support and within the bowl. The spacing between the inside surface of the bowl and the outside surface of the cone at any given point opens and closes as this cone oscillates inside the bowl. Rocks are deposited in the spacing and the rocks slide down between these surfaces as the space opens, and the rocks are crushed as the space closes. This process and machine are well known and are the subject of numerous patents. Examples are U.S. Pat. No. 5,950,939 (CONE CRUSHER FOR ROCK) and U.S. Pat. No. 6,032,886 (ADJUSTMENT FOR ROCK CRUSHER).

In this process of rock reduction, it is not uncommon for a large chunk of metal (e.g., a tooth from a rock digging bucket) to be conveyed with the rock and deposited in the rock crusher. Such items are considered uncrushables and if not accommodated can cause severe damage to the crusher.

The process used for crushing rock accommodates these uncrushables through a mechanism known as tramp iron relief systems. For example, the bowl is mounted relative to the cone at a desired fixed spacing. However, the upper assembly, including the bowl, is seated relative to the primary support structure so as to allow lifting of the bowl relative to the cone. The mounting mechanism further typically includes, e.g., hydraulic cylinders having pistons which serve to resist such lifting of the bowl. The cylinders are pressurized to resistively hold the upper assembly and thus the bowl in place. When the resistance of the cylinders is exceeded, the upper assembly, including the bowl, will lift away from the cone and allow passage of the uncrushables.

A common companion to the tramp iron relief system is the provision of a signal that notifies the operator(s) that the bowl is being lifted. It is common to provide such system via a proximity sensor, which senses the lifting movement of the bowl. The proximity sensor can be one that generates a magnetic field and senses the presence of metal within the sphere of the magnetic field. The sensor may be mounted to the primary crusher support and, as operatively mounted, detects a metal component of the upper assembly. As the bowl is lifted away from the cone, the metal component of the upper assembly moves out of the magnetic field of the sensor and triggers an alarm, e.g., a horn, a light, or both (and may also or instead trigger a shutdown of the machine as may be desired). Such alarm alerts the operator(s) which can allow the removal of the uncrushable from the output conveyor, allow slowdown or stopping of the input conveyor, and the like or may be used as an input to a control device or system that can be used to make control adjustments or other corrective actions.

It will be appreciated by those skilled in the art that the sensor can be used in either a “normally open” or “normally closed” mode. The control and/or alarm device that is in communication with the sensor can be configured to interface with the sensor in either mode. Consequently, the sensor might be set up to send a signal when there is no detected movement and stop sending a signal when movement is detected or vise versa. These alternatives of signal operation are collectively referred to as a change of state.

### BRIEF DESCRIPTION OF THE INVENTION

Whereas the system as described above functions satisfactorily to detect and accommodate the relief of uncrushable objects, there is recognized a further need to detect not-so-dramatic lifting of the bowl. That is, for any of a number of reasons, the resistive force applied by the cylinders may be exceeded and cause the bowl to repetitively lift and reseat in rapid succession. For example, such a repetitive movement can occur simply by overloading the crusher. This repetitive movement can be damaging and may be avoided by reducing the input of the rock material, increasing the spacing between the bowl and cone, or the like. Regardless, there is a need for detecting such non-dramatic movement to alert the operator and enable adjustment of the available settings.

The prior detection system does not and cannot satisfactorily perform the task of “overload” detection as differentiated from the typical tramp iron relief for an uncrushable as described above. The nonprogrammable proximity sensors inherently have a zone of inconsistency or nonreliability between the on and off signal positions due to the existence of hysteresis. This zone of nonreliability is not a problem when detecting major lifting movement as in the passing of an uncrushable, i.e., the task of such prior sensor devices, but is not satisfactory for detecting the repetitive lifting movements, as when the crusher is overloaded.

The present invention recognizes the benefit of providing a means for detection of e.g., undesired overload movement. A programmable proximity sensor can be programmed to change state when a specific distance of movement is exceeded, and activate whatever alarm and/or control is provided.

The invention will be more fully appreciated and understood upon reference to the following detailed description having reference to the accompanying drawings.

### BRIEF DESCRIPTION OF DRAWINGS

FIG. 1 is an illustration in cross section of a rock crusher in accordance with the present invention;

FIG. 2 is an enlarged, partial view of a programmable proximity sensor mounted on a rock crusher in accordance with the present invention;

FIG. 3 serves to illustrate in diagrammatic form the operation of a non-programmable proximity sensor of the prior art; and

FIG. 4 serves to illustrate the operation of the programmable proximity sensor of the present invention.

### DESCRIPTION OF A PREFERRED EMBODIMENT

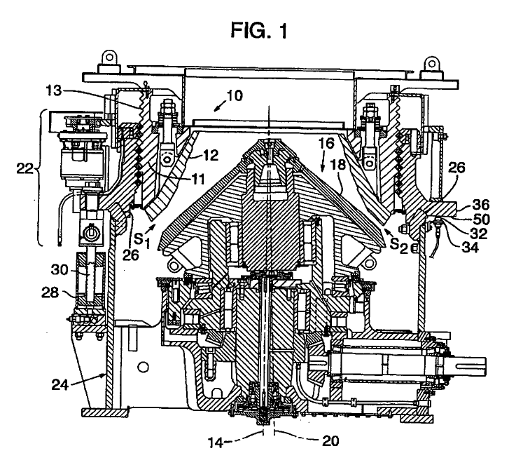

Reference is first made to FIG. 1, which illustrates a type of rock crusher to which the present invention is directed. Illustrated is an upper assembly 10 including a bowl component 11, the bowl having a conical interior wall 12. Conical wall 12 defines a center line 14. Mounted within the bowl 11 is a cone 16 having an exterior conical wall 18. The conical wall 18 defines a center line 20. The mounting of the cone 16 is such that the center line 20 oscillates about center line 14 of the bowl. As the cone 16 oscillates about center line 14, the gap or spacing between walls 12 and 18 at any given position on the circumference of wall 12 opens and closes. Compare the spacing S₁ with S₂.

In practice, the cone oscillates about center line 14 and rotates about center line 20. Rock enters the spacing, e.g., at S₁, and as the cone oscillates to close that spacing, e.g., to S₂, the rock is crushed between walls 12 and 18. Spacings S₁ and S₂ are cooperatively adjustable via the screw threads 13 on the periphery of the bowl component 11.

The above description is not intended to be complete as persons skilled in the art are familiar with both the structure and operation of such rock crushers and the different variations to that disclosed. Such crushers have similar operation and problems with respect to inadvertently including uncrushable objects along with rock to be crushed.

Again, in general, rock is dug out of rock quarries and deposited onto conveyers that typically convey the rock in an ongoing operation to the crusher. The conveyer deposits the rock into the top of the crusher. As the cone oscillates, the rock slides down between the bowl and cone as the space opens and closes. (Note that rock feed to the crusher may be by other means and the reference to conveyors is intended to be exemplary and not limiting.)

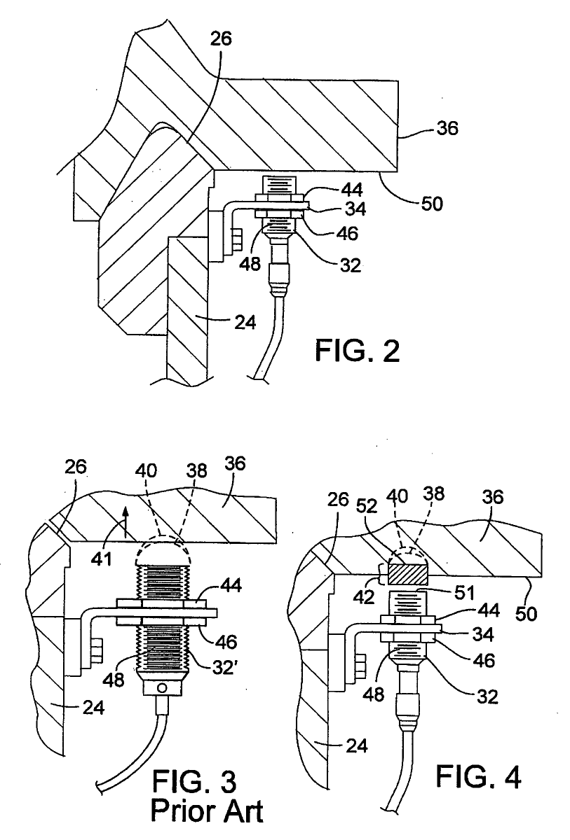

The crushing activity produces a variable upward force acting against the wall 12 of the bowl 11. The upper assembly 10 is supported on the base support 24 by a V seat arrangement indicated by reference no. 26. The male component of the V seat is provided on the base support 24 and the female component is provided on the upper assembly 10. The upward force is resisted by a hold down assembly generally indicated at reference 22. Cylinders 28 are secured to base support 24. Pistons 30 moveable within cylinders 28 are connected to the upper support 10. The cylinders 28 are pressurized to resist upward movement of the pistons 30 and thus the lifting of the upper assembly 10. Should an uncrushable object be deposited in the crusher, the upward force generated by the uncrushable object resisting crushing will produce sufficient force to both overcome the weight of the upper assembly and raise the piston 30 within the cylinder 28. Such lifting of the upper assembly 10 from the V seat 26 provides the necessary space for passing the uncrushable object. Once the uncrushable object passes through the crusher, the resistive pressure in cylinder 28 in addition to the weight of upper assembly 10 returns piston 30 for reseating of the bowl and thus continued crushing of the rock.

Whereas the tramp iron relief is essentially automatic, it is often beneficial for the operator to know that an uncrushable object is being passed through the crusher or if an overload condition exits resulting in small amplitude movement of the upper assembly. Such notification of tramp iron relief operation is provided by a sensor. The sensor is shown in FIG. 1 as item 32 but refer also to the enlargement of the sensor and its mounting in FIG. 2. As shown, the sensor 32 may be mounted on a flange 34 fixed to the base support 24 (proximal to V seat 26) and underlying a flange 36 of upper assembly 10.

A prior art version of a signal generator i.e. a proximity sensor 32′ is illustrated FIG. 3. The proximity sensor 32′ of the prior art emits a semi-spherical magnetic field represented by dash line 38 with an overlying magnetic shadow 40 referred to as hysteresis. Arrow 41 represents upward movement of flange 36 and thus upper assembly 10 and bowl 11 in relation to base support 24. As shown, the flange 36 has moved upward beyond the magnetic field 38 and not the area of hysteresis 40. It is commonly experienced that the separation movement of flange 36 to this position is not detected by the sensor. Once it moves upward beyond the hysteresis 40, the separation is detected and the sensor will signal the existence of the lifting movement, e.g., noting the passage of an uncrushable object.

It is further experienced that following passage of the uncrushable object, the flange 36 will move downward, but the non-programmable sensor will not change state until it engages the magnetic field 38. That is, the signal of the sensor may not activate until movement of the flange 36 clears the hysteresis 40, but to the contrary, return movement may not reverse that signal until flange 36 moves into the magnetic field 38. Such unreliable operation of the proximity sensor is suitable for detecting substantial separation as when a tramp iron object enters the crusher, but is not suitable for identifying more discriminate movement, as when the crusher is overloaded.

FIG. 4 illustrates the improvement of the present invention. The proximity sensor 32 of the invention is a programmable proximity sensor. It contains the ability to establish a specific zone 42 within the magnetic field 38 wherein the presence or non-presence of metal is detected. Any metal that is within the edge-specific zone 42, is detected by the sensor, as is the non-presence of metal in that zone. Such change in presence/non-presence detection produces a change of state in the sensor.

The programming of the sensor and the location of the sensor are then coordinated to provide overlap of the zone 42 (FIG. 4.) with the flange 36 so that with the upper assembly fully seated in V seat 26, the upper edge 52 of zone 42 extends a specific distance upwardly beyond the bottom surface 50 of flange 36. Whereas a position for the sensor relative to flange 36 may be fixed and the setting of the sensor zone 42 modified to produce the overlap, it will be assumed here that the case is visa versa, i.e., the zone 42 is provided with an upper edge 52 that is a precise distance upward (upward as viewed in FIG. 4) of the sensor end 51. The sensor is accordingly moved in its mounting to flange 34 (via dual clamping nuts 44, 46) to create a desired space as between the sensor end 51 and the bottom surface 50 of flange 36. This then provides the location of zone 42 and any lifting movement of the bowl 10 equal to or less than that which will keep edge 50 within zone 42 will be undetected and any movement that locates edge 52 below edge 50 (outside zone 42) will be detected, changing the state of the sensor and sending a signal to the operator of the undesired lifting movement.

Those skilled in the art will appreciate that rock crushers can take many different forms and the invention is directed to the use of programmable proximity sensors to detect smaller amplitude movements than are possible with nonprogrammable proximity sensors. The invention is defined accordingly in the following claims wherein the terms are to be interpreted in their broad meaning and intent consistent with this disclosure.

1. A rock crusher including a detection system comprising:
a cone and bowl mounted on support structures in offset and spaced relation for relative rotative and oscillating movement wherein said movement opens and closes a passageway to effect crushing of rock and other friable materials;
said cone and bowl as mounted, including relief mechanism effecting a determined force for maintaining said spaced relation, and permitting expansion of said spaced relation when said determined force is exceeded;
a sensor that senses and signals an occurrence of the spaced relation being expanded; and
said sensor including a programmable proximity sensor programmed to identify a specific outer limit of permitted expansion and which signals the occurrence of permitted expansion outside that specific outer limit and the occurrence of return movement back through that specific outer limit.

2. A rock crusher as defined in claim 1 wherein the sensor is fixedly mounted on one of the cone and bowl support structure and a target surface on the other of the cone and bowl or their support structure, a magnetic field extended from a face of the sensor such that said target overlaps said magnetic field, said sensor programmed to define an outer limit within the magnetic field at a specific distance from the face of said sensor such that movements of the target area outward through said outer limit and inward back through said outer limit will cause the sensor to change state.

3. A rock crusher as defined in claim 2 wherein the fixedly mounted position of said sensor may be adjusted such that the outer limit relative to the target area of the other structure may be set at different positions.

4. A detection system comprising:
a rock crusher including a cone support assembly and bowl support assembly cooperatively placing a cone and bowl in spaced relation for receiving and crushing rock or other friable material;
a relief mechanism enabling a pressure-induced increase of said spaced relation;
at least one programmable proximity sensor mountably fixed relative to one of said cone and bowl support assemblies and a metallic target on the other of said cone and bowl support assemblies, said sensor and metallic target cooperatively structured whereby movement of the target area beyond a specified limit and back into said specified limit will cause the sensor to change state;
a signal actuating device responsive to said change of state for activating an alarm and/or control.

5. A detection system as defined in claim 4 wherein the sensor is adjustably mounted to enable adjustment of the sensor position to thereby adjust the location of the sensor relative to the target.

6. A detection system comprising:
a rock crusher including a cone and bowl in spaced relation for receiving and crushing rock and other friable material;
a relief mechanism responsive to a force induced increase of said spaced relation;
a programmable proximity sensor programmed and applied to identify a specific outer limit of said force induced increase of said spaced relation and changing state at both occurrences when said outer limit is exceeded and when said outer limit is reestablished; and
an alarm and/or control actuated by said changing state at both occurrences.
